(19) United States
(12) Patent Application Publication
(10) Pub. No.: US 2025/0186954 A1
(43) Pub. Date: Jun. 12, 2025

(54) POLYMER DISSOLUTION EQUIPMENT SUITABLE FOR LARGE HYDRAULIC FRACTURING OPERATIONS

(71) Applicant: SNF Group, ANDREZIEUX BOUTHEON (FR)

(72) Inventors: Dorian ROTIER, ANDREZIEUX BOUTHEON (FR); Maxence RUIZ, ANDREZIEUX BOUTHEON (FR); Flavien GATHIER, ANDREZIEUX BOUTHEON (FR); Changfa ZHU, TAIXING CITY (CN)

(21) Appl. No.: 18/941,436

(22) Filed: Nov. 8, 2024

(30) Foreign Application Priority Data
Nov. 10, 2023 (FR) 2023114940613

(51) Int. Cl. B01F 33/80; B01F 21/00; B01F 23/50; B01F 23/53; B01F 27/272; B01F 33/502; B01F 33/82; B01F 33/83; B01F 35/71; B01F 101/49; B65G 3/04; B65G 33/26; B65G 65/38; E21B 43/26

(52) U.S. Cl. CPC B01F 33/83613; B01F 21/40; B01F 23/53; B01F 23/54; B01F 23/56; B01F 27/2723; B01F 33/5023; B01F 33/8212; B01F 33/83; B01F 35/71731; B01F 35/71775; B01F 35/71815; B65G 3/04; B65G 33/265; B65G 65/38; B01F 2101/49; B01F 2215/0427; B01F 2215/0431; B01F 2215/045; B65G 2201/042; B65G 2812/0577; E21B 43/2607

(57) ABSTRACT

A compact and transportable equipment adapted to be used for hydraulic fracturing operations on gas or oil fields includes a means for unloading powder polymer, a means for supplying a polymer powder to a silo, and a silo for storing polymer in powder form, the silo having inside a vertical screw located in a vertical pipe, the lower end of the shaft of the vertical screw extending outside of the silo. The equipment has a feed hopper of a polymer metering device, a device for metering out the powder polymer, at least one tank for hydrating and dissolving the dispersed polymer originating from the dispersing and grinding device, and at least one volumetric pump enabling injection and metering of the polymer solution. The lower end of the shaft of the vertical screw has a rotating ring, the rotating ring being perpendicularly fixed on the shaft and being equipped with at least three straight paddles, positioned perpendicularly to the horizontal plan of the ring.

### RELATED APPLICATION

This application claims the benefit of priority from Chinese Patent Application No. 2023 114940613, filed on Nov. 10, 2023, the entirety of which is incorporated by reference.

### FIELD OF THE INVENTION

The present invention relates to a compact and transportable equipment adapted to be used for fracturing operations on gas or oil fields in order to have the required buffer powder volume. The equipment comprises a screw conveyor system for transferring fine powders to a feed hopper. More precisely, that is also named in the following description a “screw conveyor system” comprises an unloading logistics platform, a horizontal unloading screw, and a silo. The silo contains a vertical pipe within which an upwardly extending vertical screw is located, said screw having specific features designed to improve the process of transferring fine powders, in hydraulic fracturing operations.

### BACKGROUND OF THE INVENTION

In hydraulic fracturing operations, several crucial additives like drag reducers are present in fine powders forms. Indeed, the selection of fines is particularly useful to reach optimal performances in terms of viscosifying effect and suspensive effect in the injection fluid.

Fines are preferably obtained by sieving and/or grinding a powder after drying. So generally, fine powders refer to a powdered raw material whose granularity is smaller than usual powder, i.e., comprised a particle size between 20 μm and 500 μm. Due to their particle size, it is very difficult to handle and transfer fine powders.

The key objective of this invention is to optimize the flow characteristics of fine powders during the transfer process by using an improved dedicated equipment.

CN103381339A discloses a compact equipment comprising a pneumatic means for supplying a silo with powder polymer, a silo for storing polymer in powder form, a means for conveying the polymer from the silo into a feed hopper, a feed hopper of a polymer metering device, a device for metering out the powder polymer, a device for dispersing and grinding the polymer which is also named PSU (Polymer Slicing Unit), and tanks for hydrating and dissolving the dispersed polymer.

Conveyor systems for transferring fine powder which are disclosed are pneumatic systems. Pneumatic systems encounter issues such as clogging, bridging, and erratic flow patterns, resulting in operational inefficiencies and production downtime. In addition, they often suffer from issues such as air leakage, energy inefficiency, complex air treatment and high maintenance requirements.

CN102713131 A discloses a compact and transportable installation which is adapted to be positioned on a trailer. The installation successively includes a rail with a hoist to unload big bags of 750 kg, a hopper positioned under the big bag, an horizontal screw, a vertical hopper comprising a vertical screw to bring the powder fed by the previous screw into the hopper, an overflow pipe supplying a screw feeder, a dispersion device like a PSU (Polymer Slicing Unit), a vertical tank receiving the suspension obtained in the dispersion device, and a volumetric pump to inject and dose the solution of polymer obtained at the suction of the high pressure pump enabling the fracturing work.

This installation has several drawbacks like a speed of processing which is incompatible with large-scale recovery operations, the impossibility of being supplied in bulk during operation, the difficulty of metering out and dispersing the polymer at high concentration among others.

The problem to be solved is then to develop an improved equipment avoiding interruption during operation and using a mechanical powder transfer system instead of a pneumatic system.

### OBJECTS AND SUMMARY

The present invention eliminates the need for cumbersome and complex pneumatic systems, which are associated with various drawbacks and offers a game-changing solution to the challenges faced in handling and transferring. Indeed, the screw conveyor system of the invention aims to replace the pneumatic fine powders transfer systems, with a more efficient and reliable solution thus by incorporating advanced features and optimized design elements.

This invention offers significant advantages over traditional pneumatic system. Notably, the improved vertical screw design addresses these concerns by incorporating advanced features that promote reliable and consistent powder flow which is compatible with storage of powder at a high flow rate. The invention also provides a reliable and low-maintenance alternative, reducing operational costs and downtime.

Another challenge with pneumatic transfer is the air treatment to get rid of all the fines and their hydrophobic properties. No air treatment nor dust filters are required with the screw conveyor system of the invention as the transfer is performed under atmospheric conditions.

Furthermore, the screw conveyor system also takes into consideration easy installation and maintenance. Moreover, the design enables straightforward access and cleaning, reducing downtime and enhancing operational efficiency.

By optimizing powder flow, reducing blockages, and improving overall system performance, this invention aims to set a new standard for fine powder transfer in hydraulic fracking, contributing to more sustainable and streamlined operations in the industry.

The present invention relates to a compact and transportable equipment adapted to be used for hydraulic fracturing operations on gas or oil fields, said equipment comprising means for unloading powder polymer, a silo for storing polymer in powder form, a feed hopper, a device for metering out the powder polymer, a PSU, at least 1 tank for hydrating and dissolving the dispersed polymer, and at least one volumetric pump enabling injection and metering of the polymer solution.

According to the invention, inside of the silo contains a vertical screw located in a vertical pipe, the lower end of the shaft of the vertical screw extending outside of the silo and comprises a rotating ring, said rotating ring being perpendicularly fixed on the shaft and being equipped with at least 3 straight paddles, positioned perpendicularly to the horizontal plan of the ring.

Practically, the paddles ensure gentle and controlled fluidization of fine powders. These paddles are designed to minimize powder compression and prevent clumping, allowing for a smooth and uninterrupted flow. It ensures a consistent and controlled flow, minimizing powder degradation and particle breakage during transfer.

More precisely, the invention concerns a compact and transportable equipment adapted to be used for hydraulic fracturing operations on gas or oil fields, said equipment comprising, successively:
means for unloading powder polymer having a size in the range from 20 to 500 micrometers (μm),
means for supplying a polymer powder to a silo,
a silo for storing polymer in powder form, said silo having inside a vertical screw located in a vertical pipe, the lower end of the shaft of the vertical screw extending outside of the vertical pipe, itself extending outside of the silo,
a feed hopper of a polymer metering device,
a device for metering out the powder polymer,
a device for dispersing and grinding the polymer, said device comprising:
   a cone for wetting the powder polymer connected to a primary water inlet circuit,
   at the lower end of the cone:
      a dispersed polymer grinding and drainage chamber comprising:
         a motor-driven rotor equipped with blades,
         a fixed stator constituted of a cylinder equipped with thin slots,
   over all or part of the periphery of the chamber, a ring supplied by a secondary water circuit, the ring communicating with the chamber so as to ensure spraying of pressurized water over an outside of the stator, thus enabling release of ground and swollen polymer at a surface of said stator,
at least 1 tank for hydrating and dissolving the dispersed polymer originating from the dispersing and grinding device,
at least one volumetric pump enabling injection and metering of the polymer solution.

The invention is characterized in that the lower end of the shaft of the vertical screw comprises a rotating ring, said rotating ring being perpendicularly fixed on the shaft and being equipped with at least 3 straight paddles, positioned perpendicularly to the horizontal plan of the ring.

In order to optimize the handling of different powder densities and flow rates, the vertical screw design incorporates a side edge all along its length.

Especially, the vertical screw has at least one of the following features:
a length between 150 and 350 cm, preferably from 250 to 300 cm,
a diameter between 100 mm and 350 mm, preferably from 150 to 250 mm,
a pitch between 75 and 150 mm, preferably from 90 to 130 mm,
the teeths have a crest have a height between 5 to 30 mm,
the input flow rate and the output flow rate is between 1.8 to 3.2 T/hour, preferably from 2 to 2.8 T/hour.

Always for the same purpose of improving the efficiency of the handling of different powders, the space between the vertical pipe and the crest of the teeth of the screw is between 3 mm to 12 mm. To further enhance performance, the vertical screw is treated with a specific surface finish that reduces friction and promotes powder flow.

Particularly, the internal surface of the vertical pipe and the vertical screw have a fluorinated thermosetting organic resins surface finish. This surface finish is specifically formulated to minimize powder adhesion, thereby preventing build-up and blockages within the silo system. Advantageously, the resin is chosen in the group containing polytetrafluoroethylene, perfluoroalkoxy, fluorinated ethylene propylene and ethylene tetrafluoroethylene.

To guarantee a certain volume of available powder, i.e avoiding interruption during operation, the silo has a volume of at least 5 m³. Such a volume is reached thank to a specific geometry.

According to a specific embodiment, the silo is horizontal, of parallelepipedal shape and is equipped with a dihedron-shaped base and has a volume greater than 10 m³.

In order to supply the feed hopper with the powder polymer, the upper end of the vertical pipe has a prolongating part extending downward through a lateral side of the silo, said prolongating part having means for connecting to the feed hopper.

According to some other characteristics:
means for supplying the silo with powder polymer have a form of a screw inserted in a horizontal pipe,
means for unloading powder polymer has a form of a vibratory hopper configured to receive big bags filed with powder polymer.

Advantageously, the equipment of the invention further comprises protection control, instrumentation and safety electrical equipment arranged in an electrical room, said protection control, instrumentation and safety electrical equipment controlled by a programmable controller that allows total automation of the equipment with control via a main control room of the whole of the fracturing operation.

In a preferred embodiment, the equipment is positioned in a container or on a trailer.

The invention and the advantages that result therefrom will become more clearly apparent from the following exemplary embodiment in support of the appended figures.

### BRIEF DESCRIPTION OF THE DRAWINGS

FIG. 1 is a general view of the equipment of the invention positioned on a trailer.

FIG. 2 is a lateral view of a part of the trailer.

FIG. 3 is a view of the rear of the trailer.

FIG. 4 is an exploded view of the assembly comprising means for supplying the polymer and the silo.

FIG. 5 is a view of the lower part of the assembly formed by the vertical pipe and the vertical screw.

### DETAILED DESCRIPTION OF THE INVENTION

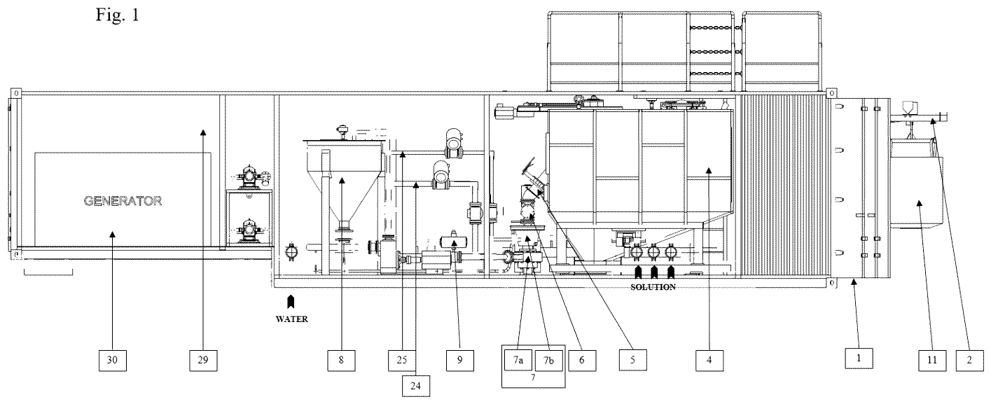

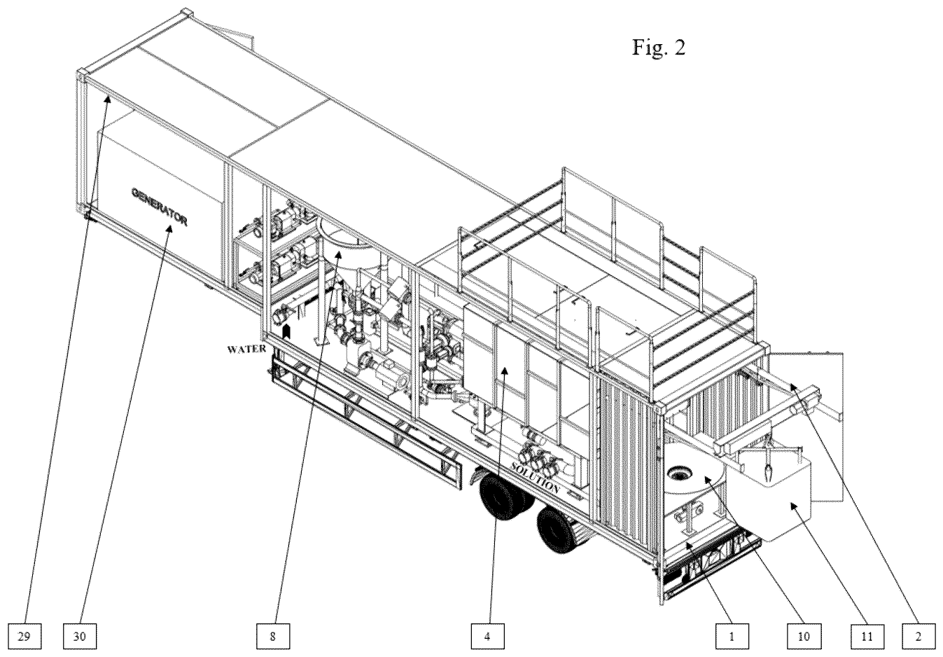

FIGS. 1 and 2 represent a specific embodiment of the invention where the equipment is positioned on a trailer (1). Such equipment is adapted to be used for fracturing operations on gas or oil fields. Typically, the trailer (1) and has a weight of less than 24 tons, preferably less than 22 tons, considering the amounts of polymer solutions contained in the tanks, and the amount of powder contained in the silo, allowing an immediate start-up. Furthermore, the equipment will not exceed a length of 14 meters, preferably 12 meters.

This equipment is essentially composed of:
an unloading logistics platform (2),
a horizontal pipe (3) for supplying a polymer powder to a silo (4)
a silo (4) for storing polymer in powder form,
a feed hopper (5),
a device (6) for metering out the powder polymer,
a device for dispersing and grinding the polymer (7),
a buffer tank (8) for hydrating and dissolving the dispersed polymer,
a volumetric pump (9) enabling injection and metering of the polymer solution.

### Unloading Logistics Platform

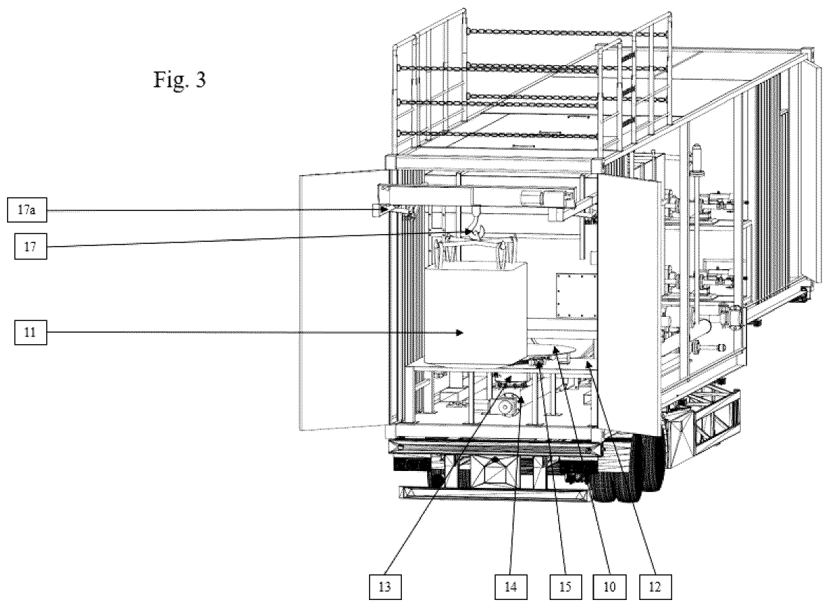

The unloading logistics platform (2) is represented in more details on FIG. 3.

For making the discharge of the ultrafine powder easier, the unloading logistics platform is equipped with a vibratory hopper (10) configured to receive big bags (11) filed with powder polymer. In more details, the platform comprises a vibratory hopper (10) mounted on a frame (12), the lower part (13) of the vibratory hopper (10) being connected by a chamber (14) to means for supplying the silo (4) with powder polymer The outer wall of the vibratory hopper is equipped with vibrators, advantageously 4 vibrators (15). The platform also comprises a rail (17a) with a hoist (17) to unload big bags (11). Unloading conditions can be adapted to suit logistical conditions.

Practically, fine powders arrive in 500 to 800 kg big bags, more preferably in a 750 kg big bags. The particle size of the fine powders polymer is in the range from 20 to 500 micrometers (μm), preferably from 30 to 400 micrometers (μm), more preferably from 50 to 300 micrometers (μm).

### Means for Supplying the Silo

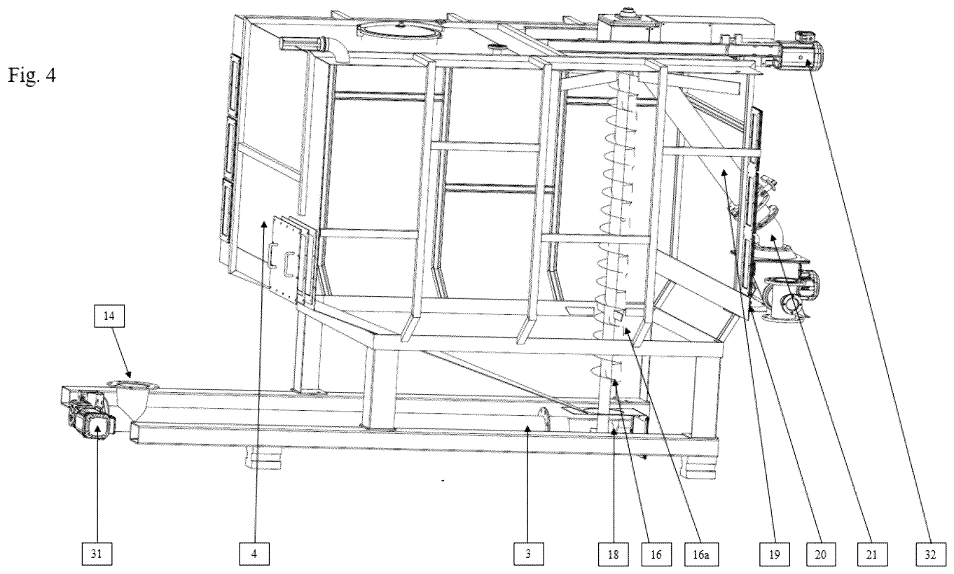

Means for supplying the silo (4) with fine powders polymers has a form of a screw inserted in a horizontal pipe (3). The horizontal pipe is positioned at the base of the silo (4) as shown on FIG. 4. The horizontal screw has a length of 200 mm and is powered by a motor (31).

### Silo for Storing Polymer in Powder Form

As illustrated on FIG. 4, the storage silo (4) is horizontal, of parallelepipedal shape and is equipped with a dihedron-shaped base. The silo has a volume 13 m³.

In one preferred embodiment, the horizontal storage silo (4) contains vibrators, each having a vibration frequency of 50 Hz and an output of 550 W are mounted on the outer wall.

According to the invention, the silo (4) has inside a vertical screw (16) located in a vertical pipe (16a), the lower end of the shaft (18) of the vertical screw (16) extending outside of the vertical pipe (16a), itself extending outside of the silo (4).

The upper end of the vertical pipe (16a) has a prolongating part (19) extending downward through a lateral side (20) of the silo, said prolongating part (19) having means (21) for connecting to the feed hopper (5). The vertical pipe (16a) has a fluorinated thermosetting organic resins surface finish such as polytetrafluoroethylene, perfluoroalkoxy, fluorinated ethylene propylene and ethylene tetrafluoroethylene. Preferably, the vertical pipe has a polytetrafluoroethylene surface finish.

The vertical screw (16) is designed with specific features to optimize the process of transferring fine powders, in hydraulic fracturing operations. The vertical screw is powered by a motor (32).

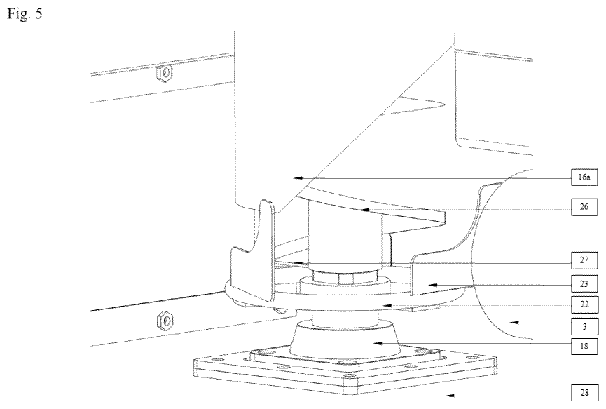

Accordingly, as especially shown on FIG. 5, the lower end of the shaft (18) of the vertical screw (16) comprises a rotating ring (22), said rotating ring (22) being perpendicularly fixed on the shaft (18) and being equipped with 3 straight paddles (23), positioned perpendicularly to the horizontal plan of the rotating ring (22). The paddles (23) have a L shape; with the dimension 130 mm×100 mm×2 mm. The paddles (23) ensure gentle and controlled fluidization of fine powders. The paddles (23) are designed to minimize powder compression and prevent clumping, allowing for a smooth and uninterrupted flow. It ensures a consistent and controlled flow, minimizing powder degradation and particle breakage during transfer.

The vertical screw (16) has a series of teeth (26) with lateral edges (27) ranging from 5 to 30 mm, to fluidize fines and guide them inside enabling maximum throughput and efficiency per revolution.

The vertical screw (16) comprises a bearing system mounted on the upper end and the lower end to rotate the screw counterclockwise.

The vertical screw (16) comprises a bearing system mounted on the upper end and the lower end to rotate the screw counterclockwise.

The vertical screw (16) has a diameter of 200 mm, a length of 297 cm for raising the fine powders at a flow rate of 2.5 T/hour above the device for dispersing and grinding the polymer.

The vertical screw (16) has a fluorinated thermosetting organic resins surface finish such as polytetrafluoroethylene, perfluoroalkoxy, fluorinated ethylene propylene and ethylene tetrafluoroethylene. Preferably, the vertical screw has a polytetrafluoroethylene surface finish to prevent the powder from sticking to the shafts.

The space between the vertical pipe (16a) and a series of teeth (26) of the vertical screw (16) is between 3 mm to 12 mm.

The vertical screw (16) has an input flow rate between 1.8 to 3.2 T/hour, preferably from 2 to 2.8 T/hour.

The vertical screw (16) has an output flow rate also between 1.8 to 3.2 T/hour, preferably from 2 to 2.8 T/hour.

According to another characteristic, the horizontal pipe (3) is connected to the vertical screw (16) through a chamber (28) located outside of the silo and encasing the lower end of the shaft (18) of the vertical screw (16), the rotating ring (22) fixed on the shaft (18) and the paddles (23).

### The Device for Dispersing and Grinding the Polymer.

The device for dispersing and grinding the polymer (7) is a PSU of the same type that the one which is disclosed in WO2008/107492.

The PSU (7) is improved by increasing the rotor-stator diameter to 210 mm. The PSU (7) is fed at the upper portion with 10 m³/h of powder polymer and at the lower portion (7a) with from 0 to 20 m³/h of water circulating in the pipe. The water and powder flow rates may be adjusted as a function of the desired conditions.

The water circulating in the pipe (24, 25) and powder are mixed in a wetting cone (7b) that may be a polytetrafluoroethylene coated to prevent the powder from sticking to the cone (7b). Indeed, the fracturing operations often take place on cursorily levelled agricultural lands.

Each pipe (24, 25) is supplied in water, by water pump making it possible to avoid the very large pressure variations of the feed lines during operations. The flow rate is 80 m³/h at a pressure of 3 bar and an NPSH (net positive suction head) of 3 meters.

The suspension obtained in the PSU (7) is sent into a 750 L buffer tank (8).

At the outlet of the buffer tank (8), the solution is metered out by one variable-speed volumetric pumps (9). The pump may advantageously be Waukesha lobe pumps model 60, flow rate 80 m³/h. The flow rate may be modified from the main control room as a function of the observed injection pressures.

All the control, protection, instrumentation and safety electrical equipment is located in an electrical room (29) and is controlled by a programmable controller that allows total automation of the equipment with control via the main control room of the whole of the fracturing operation.

Finally, the installation also comprises an electrical generator (30) allowing an autonomous power supply of the onboard equipment, of 240 kW with a fuel tank allowing full operation.

1/ A compact and transportable equipment adapted to be used for hydraulic fracturing operations on gas or oil fields, said equipment comprising, successively:
a means for unloading powder polymer having a size in the range from 20 to 500 micrometers (μm),
a means for supplying a polymer powder to a silo,
a silo for storing polymer in powder form, said silo having inside a vertical screw located in a vertical pipe, the lower end of the shaft of the vertical screw extending outside of the vertical pipe, itself extending outside of the silo,
a feed hopper of a polymer metering device,
a device for metering out the powder polymer,
a device for dispersing and grinding the polymer, said device comprising:
a cone for wetting the powder polymer connected to a primary water inlet circuit,
at the lower end of the cone:
a dispersed polymer grinding and drainage chamber comprising:
a motor-driven rotor equipped with blades,
a fixed stator constituted of a cylinder equipped with thin slots,
over all or part of the periphery of the chamber, a ring supplied by a secondary water circuit, the ring communicating with the chamber so as to ensure spraying of pressurized water over an outside of the stator, thus enabling release of ground and swollen polymer at a surface of said stator,
at least one tank for hydrating and dissolving the dispersed polymer originating from the dispersing and grinding device, and
at least one volumetric pump enabling injection and metering of the polymer solution;
wherein the lower end of the shaft of the vertical screw comprises a rotating ring, said rotating ring being perpendicularly fixed on the shaft and being equipped with at least three straight paddles, positioned perpendicularly to the horizontal plan of the ring.

2/ The compact and transportable equipment according to claim 1, wherein the upper end of the vertical pipe has a prolongating part extending downward through a lateral side of the silo, said prolongating part having means for connecting to the feed hopper.

3/ The compact and transportable equipment according to claim 1, wherein the vertical screw has at least the following features:
a length between 150 and 350 cm,
a diameter between 100 mm and 350 mm,
a pitch between 75 and 150 mm, and
the teeth have a crest having a height between 5 to 30 mm.

4/ The compact and transportable equipment according to claim 1, wherein the vertical screw has an input flow rate and an output flow rate between 1.8 to 3.2 T/hour.

5/ The compact and transportable equipment according to claim 1, wherein the space between the vertical pipe and the crest of the teeth of the screw is between 3 mm to 12 mm.

6/ The compact and transportable equipment according to claim 1, wherein the internal surface of the vertical pipe and the vertical screw are treated with a fluorinated thermosetting organic resins surface finish.

7/ The compact and transportable equipment according to claim 1, wherein the silo is horizontal, of parallelepipedal shape and is equipped with a dihedron-shaped base and has a volume greater than 10 m³.

8/ The compact and transportable equipment according to claim 1, wherein the means for supplying the silo with powder polymer have a form of a screw inserted in a horizontal pipe.

9/ The compact and transportable equipment according to claim 1, wherein the means for unloading powder polymer comprises a vibratory hopper configured to receive big bags filled with powder polymer.

10/ The compact and transportable equipment according to claim 1, wherein said compact and transportable equipment further comprises protection control, instrumentation and safety electrical equipment arranged in an electrical room, said protection control, instrumentation and safety electrical equipment controlled by a programmable controller that allows total automation of the equipment with control via a main control room of the whole of the fracturing operation.

11/ The compact and transportable equipment according to claim 1 wherein the equipment is positioned in a container or on a trailer.
